(19) United States
(12) Patent Application Publication
(10) Pub. No.: US 2007/0121024 A1
(43) Pub. Date: May 31, 2007

(54) BACKLIGHT ASSEMBLY AND DISPLAY DEVICE HAVING THE SAME

(75) Inventors: Pil-Nam LIM, Seoul (KR); Dong-Lyoul SHIN, Suwon-si, Gyeonggi-do (KR); Tae-Seok JANG, Seoul (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD, Suwon-si (KR)

(21) Appl. No.: 11/562,717

(22) Filed: Nov. 22, 2006

(30) Foreign Application Priority Data
Nov. 25, 2005 (KR) 10-2005-0113312

(51) Int. Cl. G02F 1/1333

(52) U.S. Cl. 349/58

(57) ABSTRACT

A backlight assembly having improved luminance uniformity of emitted light, and a display device having the backlight assembly, includes first and second lamps, a receiving container and a reflection plate. The first and second lamps are arranged on a bottom plate of the receiving container substantially parallel to each other and emit ultraviolet light rays. The reflection plate is fixed on the bottom plate under the first lamp and extends to a space above the second lamp. A fluorescent layer is formed on the reflection plate. The fluorescent layer converts the ultraviolet light rays emitted from the first and second lamps into visible light rays. Luminance uniformity of light emitted from the backlight assembly is improved and a display quality of the display device is improved.

This application claims priority to Korean Patent Application No. 2005-113312, filed on Nov. 25, 2005, and all the benefits accruing therefrom under 35 USC § 119, the contents of which in its entirety are herein incorporated by reference.

### BACKGROUND OF THE INVENTION

1. Field of the Invention

The present invention relates to a backlight assembly and a display device having the same. More particularly, the present invention relates to a backlight assembly capable of emitting light uniformly and a display device having the same.

2. Description of the Related Art

In general, a display device is required to have various characteristics and functions due to progress of information society and rapid development of notebook computers, office automation devices, etc. That is, the display device is required to have lower power consumption, a higher resolution and full color. Further, an image screen of the display device is required to have a larger size, a lighter weight and a thinner thickness. A liquid crystal display (“LCD”) has been widely used in various display devices to satisfy the above mentioned characteristics and functions. The LCD has been remarkably noticed as a substitute display device for a cathode ray tube.

The LCD device is a non-emissive type display device, such that the LCD device necessarily requires a light source such as a backlight assembly to supply a backside of a LCD panel of the LCD device with light. A cold cathode fluorescent lamp (CCFL) is most often used as the light source. An optical characteristic of the light provided from the backlight assembly to the display panel largely influences a display characteristic of the display panel. When luminance of the light is not uniform, a bright line is generated in the display panel. The bright line deteriorates a display quality of the display panel.

In addition, the backlight assembly can be classified into a direct illumination type backlight assembly and an edge illumination type backlight assembly according to a position of the light source. In the direct illumination type backlight assembly, a plurality of CCFLs is positioned under the display panel. In the edge illumination type backlight assembly, a CCFL is placed at a side edge of a light-guide plate for guiding the light to the display panel. In the direct illumination type backlight assembly, luminance above the CCFL proximate the display panel is higher than that between or within the CCFL so that the bright line is prominently generated in the is display panel. Various optical sheets, a diffusion plate or a diffusion sheet for example, are used for preventing the generation of the bright line in the display panel.

The diffusion plate or the diffusion sheet is manufactured by an injection molding process or an extrusion molding process. Accordingly, in both processes, an amount of a diffusion bead is hardly controlled, and thus, a permeability of the diffusion sheet or the diffusion plate is difficult to control. In addition, a manufacturing cost of the diffusion plate or the diffusion sheet is high. For the above reasons, luminance uniformity is not sufficiently improved.

The CCFL serving as the light source of the backlight assembly includes a lamp tube and a fluorescent body spread within an inner wall of the lamp tube to emit visible light rays. In a design of a shape and a measurement of an optical member such as the reflection plate for improving efficiency of using the visible light rays, the design of the shape and the measurement is not easy using visible light rays having a bandwidth of light wider than that of an ultraviolet light ray and the light is not controlled accurately. When the ultraviolet light rays irradiate the fluorescent body for a long duration of time, a color of the fluorescent body deteriorates. Therefore, a lifetime of the backlight assembly is decreased.

### BRIEF SUMMARY OF THE INVENTION

Exemplary embodiments of the present invention provide a backlight assembly having a thin thickness and is capable of emitting a light having improved luminance uniformity.

Exemplary embodiments of the present invention also provide a display device having the above-mentioned backlight assembly having a thin thickness and is capable of emitting a light having improved luminance uniformity.

According to one exemplary embodiment of the present invention, a backlight assembly is provided. The backlight assembly includes a first lamp and a second lamp, a receiving container and a reflection plate. The first and second lamps emit ultraviolet light rays. The receiving container has a bottom plate. The first and second lamps are arranged on the bottom plate substantially parallel to each other. The reflection plate is fixed on the bottom plate under the first lamp and extends to a space above the second lamp. A fluorescent layer is formed on the reflection plate. The fluorescent layer converts the ultraviolet light rays emitted from the first and second lamps into visible light rays.

In some exemplary embodiments of the present invention, the reflection plate has a first reflection portion and a second reflection portion. The first reflection portion has a concave shape for surrounding the first lamp. The second reflection portion is connected to the first reflection portion and has a concave shape for surrounding the second lamp.

In some exemplary embodiments of the present invention, a first connection part is formed at a lower end of the reflection plate. Further, a second connection part connected to the first connection part is formed at the bottom plate. The first connection part and the second connection part may include a connection protrusion and a connection groove, respectively or vice versa.

In some exemplary embodiments of the present invention, a fluorescent layer converting the ultraviolet light rays into the visible light rays is formed on the bottom plate. The receiving container further has a sidewall. The sidewall is placed on an edge of the bottom plate. A fluorescent layer is formed on an inner surface of the sidewall.

In some exemplary embodiments of the present invention, the backlight assembly further includes an optical member. The optical member is supported by the sidewall of the receiving container. A fluorescent layer is formed on a lower surface of the optical member. The optical member may improve optical characteristics of visible light rays emitted from the fluorescent layers on the reflection plate, the bottom plate and the sidewall.

In some exemplary embodiments of the present invention, the backlight assembly further includes a side cover. The side cover may receive both ends of the first and second lamps and fix both ends of the reflection plate.

According to another exemplary embodiment of the present invention, a display device is provided. The display device includes a receiving case, a plurality of lamps, a plurality of reflection plates and a display panel. The lamps emit ultraviolet light rays. The lamps are arranged parallel to each other on a bottom plate of the receiving container. The reflection plates are secured to the bottom plate between the lamps. Further, the reflection plates extend to a space above any one of the lamps. A fluorescent layer is formed on the reflection plate. The fluorescent layer converts the ultraviolet light rays emitted from the lamps into visible light rays. The display panel displays an image using the visible light rays.

In some exemplary embodiments of the present invention, the reflection plate has a first reflection portion and a second reflection portion. The first reflection portion extends from the bottom plate surrounding the first lamp. The second reflection portion extends from the first reflection portion surrounding the second lamp. The bottom plate has a slot and a lower end part of the reflection plate is inserted into the slot.

In some exemplary embodiments of the present invention, the display device further includes an optical member. A fluorescent layer is formed on a lower surface of the optical member. The optical member is positioned between the lamps and the display panel. The optical member may improve optical characteristics of the visible light rays provided to the display panel.

According to the backlight assembly and the display device having the same, the backlight assembly may emit the visible light rays having improved luminance uniformity and the display device may in turn have improved display quality.

### BRIEF DESCRIPTION OF THE DRAWINGS

Exemplary embodiments of the present invention will become readily apparent by reference to the following detailed description when considered in conjunction with the accompanying drawings in which:

FIG. 1 is a perspective view illustrating a backlight assembly in accordance with an exemplary embodiment of the present invention;

FIG. 2 is an exploded perspective view illustrating the backlight assembly in FIG. 1;

FIG. 3 is a cross-sectional view taken along line I-I′ in FIG. 2;

FIG. 4 is an enlarged cross-sectional view illustrating portion A in FIG. 3;

FIG. 5 is an exploded perspective view illustrating a backlight assembly in accordance with another exemplary embodiment of the present invention;

FIG. 6 is a partial perspective view illustrating a side cover in FIG. 5;

FIG. 7 is a partial perspective view illustrating a reflection plate guided by the side cover in FIG. 5;

FIG. 8 is a cross-sectional view taken along line II-II′ in FIG. 5;

FIG. 9 is an enlarged view illustrating portion B in FIG. 8;

FIG. 10 is an exploded perspective view illustrating a display device in accordance with another exemplary embodiment of the present invention; and

FIG. 11 is a cross-sectional view taken along line III-III′ in FIG. 10.

### DETAILED DESCRIPTION OF THE INVENTION

Various exemplary embodiments of the present invention will now be described more fully with reference to the accompanying drawings in which some of the exemplary embodiments of the present invention are shown. In the drawings, the thicknesses of layers and regions may be exaggerated for clarity.

Illustrative exemplary embodiments of the present invention are disclosed herein. However, specific structural and functional details disclosed herein are merely representative for purposes of describing exemplary embodiments of the present invention. The present invention may, however, may be embodied in many alternate forms and should not be construed as being limited to only the exemplary embodiments set forth herein.

Accordingly, while exemplary embodiments of the present invention are capable of various modifications and alternative forms, exemplary embodiments thereof are shown by way of example in the drawings and will herein be described more fully. It should be understood, however, that there is no intent to limit exemplary embodiments of the present invention to the particular forms disclosed, but on the contrary, exemplary embodiments of the present invention are to cover all modifications, equivalents, and alternatives falling within the scope of the invention. Like numbers refer to like elements throughout the description of the figures.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of exemplary embodiments of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular exemplary embodiments only and is not intended to be limiting of the exemplary embodiments of the present invention. As used herein, the singular forms “a,” “an” and “the” are intended to include the plural forms as well, unless the context clearly indicates otherwise. It will be further understood that the terms “comprises,” “comprising,” “includes” and/or “including”, when used herein, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

Spatially relative terms, such as “beneath,” “below,” “lower,” “above,” “upper” and the like, may be used herein for ease of description to describe one element or a feature's relationship to another element or feature as illustrated in the Figures. It will be understood that the spatially relative terms are intended to encompass different orientations of the device in use or operation in addition to the orientation depicted in the Figures. For example, if the device in the Figures is turned over, elements described as “below” or “beneath” other elements or features would then be oriented “above” the other elements or features. Thus, for example, the term “below” can encompass both an orientation which is above as well as below. The device may be otherwise oriented (rotated 90 degrees or viewed or referenced at other orientations) and the spatially relative descriptors used herein should be interpreted accordingly.

Exemplary embodiments of the present invention are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, exemplary embodiments of the invention should not be construed as limited to the particular shapes of regions illustrated herein but may include deviations in shapes that result, for example, from manufacturing. For example, an implanted region illustrated as a rectangle may have rounded or curved features and/or a gradient (e. g., of implant concentration) at its edges rather than an abrupt change from an implanted region to a non-implanted region. Likewise, a buried region formed by implantation may result in some implantation in the region between the buried region and the surface through which the implantation may take place. Thus, the regions illustrated in the figures are schematic in nature and their shapes do not necessarily illustrate the actual shape of a region of a device and do not limit the scope of the present invention.

It should also be noted that in some alternative implementations, the functions/acts noted may occur out of the order noted in the FIGS. For example, two FIGS. shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which exemplary embodiments of the present invention belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

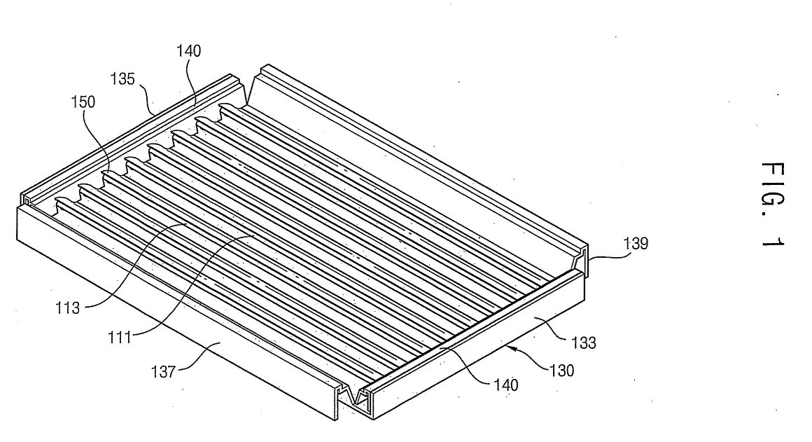

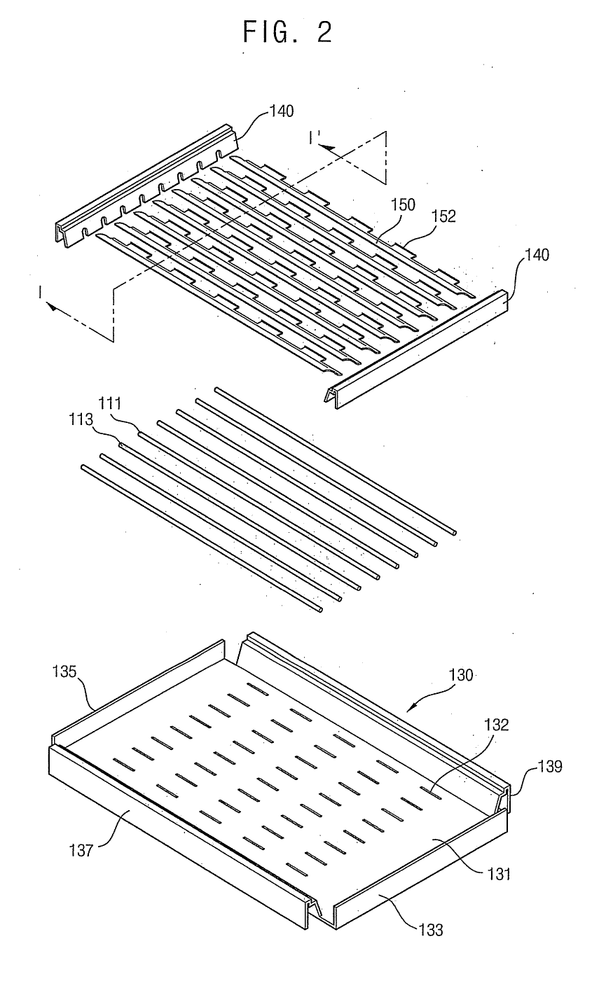

FIG. 1 is a perspective view illustrating a backlight assembly in accordance with an exemplary embodiment of the present invention. FIG. 2 is an exploded perspective view illustrating the backlight assembly in FIG. 1.

Referring to FIG. 1 and 2, the backlight assembly 100 includes a plurality of lamps 111 and 113, a receiving container 130 and a plurality of reflection plates 150.

The lamps 111 and 113 are disposed parallel to each other. Any one of the lamps 111 and 113 is referred to as a first lamp 111 and a lamp adjacent to the first lamp 111 is referred to as a second lamp 113 for convenience of explanation. The first lamp 111 and the second lamp 113 are substantially the same as each other.

For example, the first lamp 111 may have a lamp tube and electrodes. The lamp tube may include a transparent glass and may have a cylindrical shape. A discharge gas is enclosed by the lamp tube. Examples of the discharge gas may include mercury (Hg), argon (Ar), neon (Ne), xenon (Xe), krypton (Kr), etc.

The electrodes may be respectively positioned on both ends of the lamp tube. When a discharge voltage is applied from an inverter to the electrodes, an electric field is formed between the electrodes. Electrons emitted from one electrode of the electrodes collide against the discharge gas in being transferred to the other electrode of the electrodes. The discharge gas colliding against the electron is dissociated to be in a plasma state including an atom, a neutron and an electron. When the discharge gas is in the plasma state, non-visible light rays, for example, ultraviolet light rays are generated. The ultraviolet light rays are emitted outward through the lamp tube.

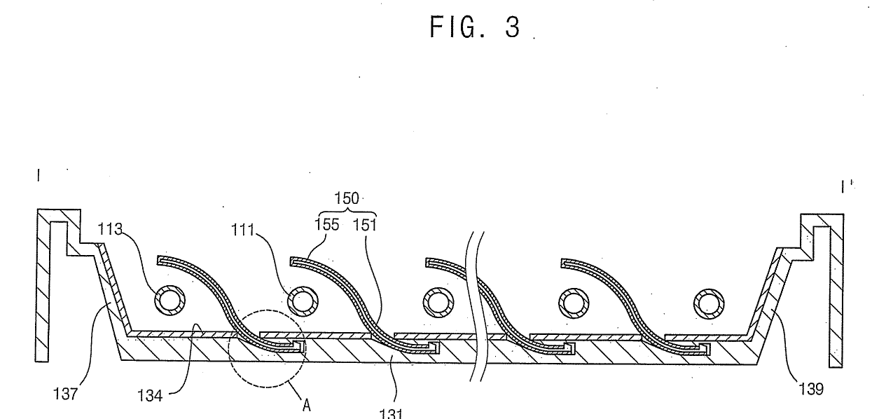

The receiving container includes a bottom plate 131 and first to fourth sidewalls 133, 135, 137 and 139, respectively. The bottom plate 131 has a rectangular shape. A first fluorescent layer 134 (refer to FIG. 3) is formed on a surface of the bottom plate 131. The bottom plate 131 has a plurality of connection grooves 132 at regular intervals along a longitudinal direction of the bottom plate 131. A row of the connection grooves 132 along the longitudinal direction includes at least two connection grooves 132. Here, the rows of the connection grooves 132 are arranged along a traverse direction of the bottom plate 132 substantially perpendicular to the longitudinal direction. In this exemplary embodiment, the number of the rows is substantially the same as the number of lamps 111 and 113.

The first to forth sidewalls 133, 135, 137 and 139 are disposed on edges of the bottom plate 131. For example, the first sidewall 133 and the second sidewall 135 face each other in the longitudinal direction. The third sidewall 137 and the fourth sidewall 139 face each other in the traverse direction. The third sidewall 137 and the fourth sidewall 139 are respectively connected to the first sidewall 133 and the second sidewall 135. Stepped portions are formed at upper inner surfaces of the third sidewall 137 and the fourth sidewall 139, respectively. The first fluorescent layer 134 (refer to FIG. 3) is formed on inner surfaces of the first to fourth sidewalls 133, 135, 137 and 139.

FIG. 3 is a cross-sectional partial view taken along line I-I′ in FIG. 2.

Referring to FIGS. 2 and 3, the first and second lamps 111 and 113 are arranged over the bottom plate 131 along a direction from the first sidewall 133 toward the second sidewall 135 to emit the ultraviolet light rays. That is, the first and second lamps 111 and 113 are disposed along the longitudinal direction. Here, the first and second lamps 111 and 113 are disposed to align with corresponding connection grooves 132.

The backlight assembly 100 further includes a pair of side covers 140 (FIGS. 1 and 2). The side covers 140 are respectively positioned on portions of the bottom plate 131 adjacent to the first sidewall 133 and the second sidewall 135. Each of the side covers 140 have a plurality of grooves for preventing the lamps 111 and 113 from interfering with one another. The side covers 140 cover ends of the lamps 111 and 113 including the first lamp 111 and the second lamp 113.

The reflection plates 150 reflect the ultraviolet light rays emitted from the lamps 111 and 113. The reflection from the reflection plates 150 converts the ultraviolet light rays into visible light rays. The visible light rays, which are reflected by the reflection plates 150 and emitted upward of the receiving container 130, have improved luminance uniformity compared to light rays, which are directly emitted from the lamps 111 and 113 without being reflected by the reflection plates 150.

The reflection plates 150 are respectively placed among the lamps 111 and 113. Here, all of the reflection plates 150 are arranged substantially in a same manner. Therefore, only one reflection plate 150 between the first lamp 111 and the second lamp 113 is illustrated herein in detail for this exemplary embodiment.

In particular, the reflection plate 150 is fixed on the bottom plate 131 under the first lamp 111 and substantially aligned with the first lamp 111, and extends to a space aligned over the second lamp 133. A second fluorescent layer (not shown) is formed on a surface of the reflection plate 150. The second fluorescent layer converts the ultraviolet light rays emitted from the first and the second lamps 111 and 113 into the visible light rays.

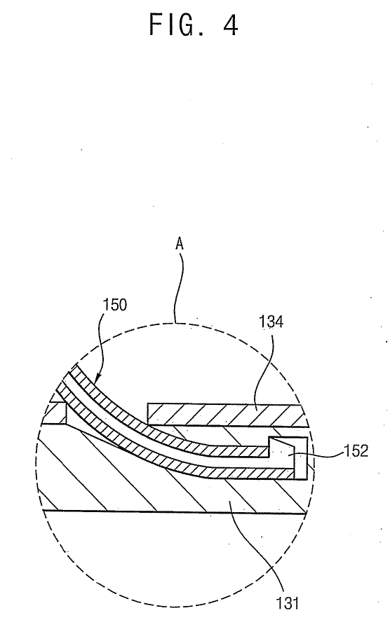

FIG. 4 is an enlarged cross-sectional view illustrating portion A in FIG. 3.

Referring to FIGS. 3 and 4, the reflection plate 150 includes a first reflection portion 151 and a second reflection portion 155.

A connection protrusion 152 is formed on a lower end of the first reflection portion 151. As shown in FIG. 4, the connection protrusion 152 is inserted into the connection groove 132 positioned under the first lamp 111. The connection protrusion 152 is connected to the connection groove 132 to fix the first reflection portion 151 to the bottom plate 131. Here, the first reflection portion 151 has a concave shape that is configured to surround the first lamp 111, as illustrated in FIG. 3.

The second reflection portion 155 extends from an upper end of the first reflection portion 151 to a space over the second lamp 113 adjacent to the first lamp 111. Here, the second reflection portion 155 has a concave shape that is configured to surround the second lamp 113, as illustrated in FIG. 3.

Accordingly, the reflection plate 150 has a curved or serpentine profile. In this exemplary embodiment, any one of the concave surfaces of the reflection plate 150 facing the bottom plate 131 of the receiving container 130 is defined as an inner surface of the reflection plate 150. The remaining concave surfaces of the reflection plate 150 directed toward an upper portion of the receiving container 130 are defined as an outer surface of the reflection plate 150.

According to this definition, the inner surface of the reflection 150 is disposed over the second lamp 113 and the outer surface of the reflection 150 is disposed under the first lamp 111.

The ultraviolet light rays emitted from the lamps 111 and 113 including the first and second lamps 111 and 113 are converted into the visible light rays by the fluorescent layer formed on the surfaces of the reflection plates 150, the surface of the bottom plate 131, and the inner surfaces of the first to fourth sidewalls 133, 135, 137 and 139 to upwardly exit from the receiving container 130.

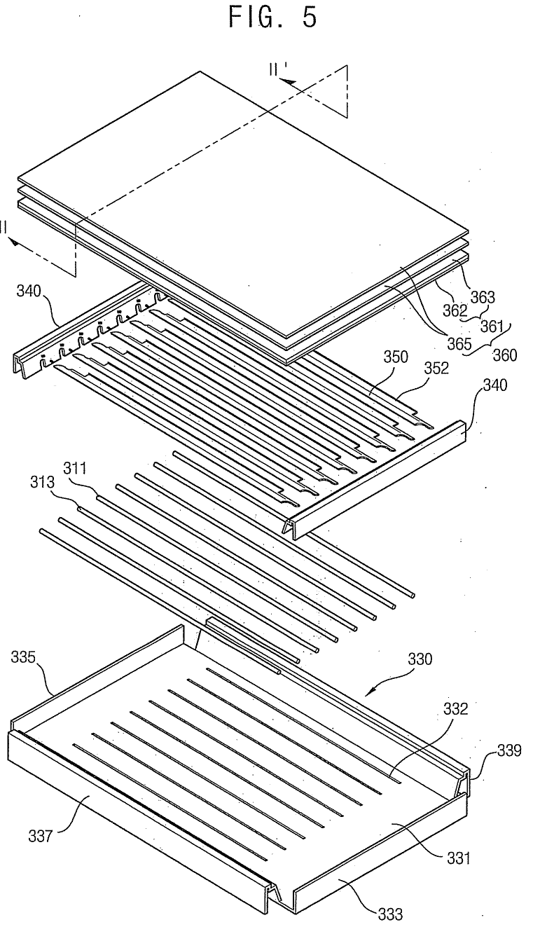

FIG. 5 is an exploded perspective view illustrating a backlight assembly in accordance with another exemplary embodiment of the present invention.

Referring to FIG. 5, the backlight assembly 300 includes a plurality of lamps 311 and 313, a receiving container 330, a pair of side covers 340, a plurality of reflection plates 350 and an optic member 360.

The lamps 311 and 313 may have a construction substantially the same as that of the lamps 111 and 113 described with reference to FIGS. 1 and 2.

The receiving container 330 may have a construction substantially the same as that of the receiving container 130 described with reference to FIGS. 1 to 4 except for a shape of a connection groove 332 formed on a bottom plate 331 and a shape of sidewalls 333, 335, 337 and 339.

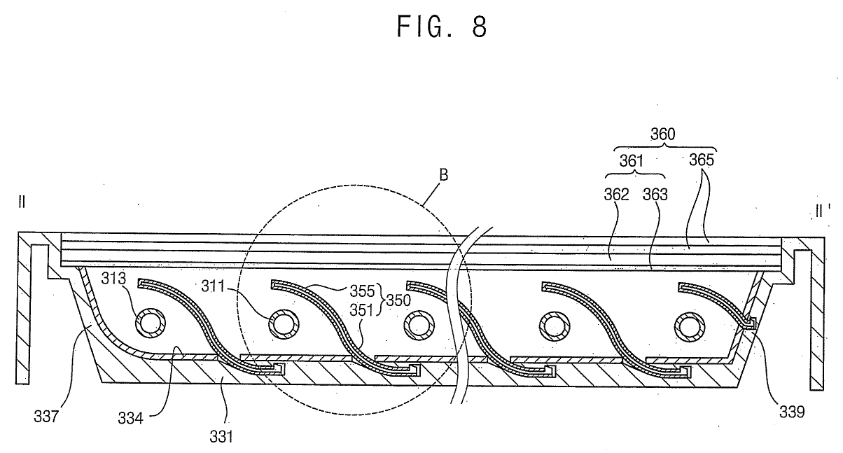

For example, the receiving container 330 includes the bottom plate 331 and first to fourth sidewalls 333, 335, 337 and 339. The bottom plate 331 has a rectangular shape. A first fluorescent layer 334 (refer to FIG. 8) is formed on a surface of the bottom plate 331. The bottom plate 331 has a plurality of connection grooves 332 at regular intervals extending along a transverse direction of the bottom plate 331. A row of the connection grooves 332 along the longitudinal direction may be one or more. Here, a row of connection grooves 332 includes a single connection groove 332 and the rows are arranged along a traverse direction of the bottom plate 332 substantially perpendicular to the longitudinal direction. In this exemplary embodiment, the number of the rows is substantially the same the number of the lamps 311 and 313.

The first to forth sidewalls 333, 335, 337 and 339 are disposed on edges of the bottom plate 331. For example, the first sidewall 333 and the second sidewall 335 face each other in the longitudinal direction. The third sidewall 337 and the fourth sidewall 339 face each other in the traverse direction. The third sidewall 337 and the fourth sidewall 339 are respectively connected to the first sidewall 333 and the second sidewall 335. Stepped portions are formed at upper inner surfaces of the third sidewall 337 and the fourth sidewall 339, respectively. A rounded portion is formed at a lower inner surface of the third sidewall 337 where the third sidewall 337 is joined to the bottom plate 331. A connection grooves 332 having the same shape as that of the connection grooves 332 formed in the bottom plate 331 is also formed on the inner surface of the fourth sidewall 339, as best seen with reference to FIG. 8. The first fluorescent layer 334 is formed on inner surfaces of the first to fourth sidewalls 333, 335, 337 and 339.

The first and second lamps 311 and 313 are arranged over the bottom plate 331 along a direction from the first sidewall 331 toward the second sidewall 333 to emit the ultraviolet light rays. That is, the first and second lamps 311 and 313 are placed along the longitudinal direction. Here, the first and second lamps 311 and 313 are positioned corresponding to a respective connection groove 332.

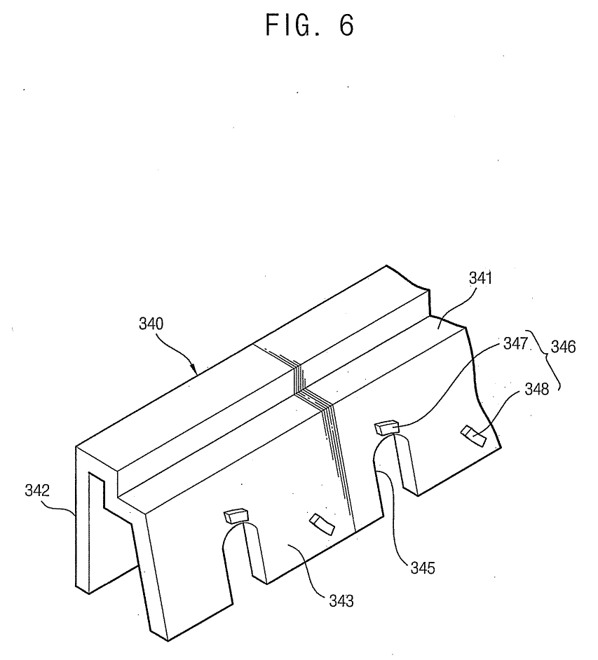

FIG. 6 is a partial perspective view illustrating a side cover in FIG. 5.

Referring to FIGS. 5 and 6, the side covers 340 may have a construction substantially the same as that of the side covers 140 described with reference to FIGS. 1 and 2 except for having a guide portion 346.

For example, the side covers 340 include an upper plate 341, an outer supporting plate 342 and an inner supporting plate 343. The upper plate 341 extends along the traverse direction of the bottom plate 331 and faces the bottom plate 331. A stepped portion is formed at the upper plate 341.

The outer and inner supporting plates 342 and 343 of each side cover 340 extend from a corresponding end deposed in the longitudinal direction of the bottom plate 331. In the side cover 340 neighboring the first sidewall 333, the outer supporting plate 342 is placed adjacent to the first sidewall 333 and grooves 345 are formed at the inner supporting plate 343 for preventing the lamps 311 and 313 from interfering with each other. The outer and inner supporting plates 342 and 343 make contact with the bottom plate 331 so that the side covers 340 cover ends of the lamps 311 and 313 including the first and second lamps 311 and 313.

The guide portion 346 for guiding the reflection plate 350 is formed at the inner supporting plate 343 of each side cover 340. For example, the guide portion 346 includes first and second protrusions 347 and 348 formed at the inner supporting plate 343. As shown in FIG. 6, the first protrusion 347 is formed over a corresponding groove 345 and the second protrusion 348 is formed between adjacent grooves 345. Contacting surfaces of the first and second protrusions 347 and 348, which make contact with the reflection plate 350, have a curved surface contoured to a profile of the reflection plate 350.

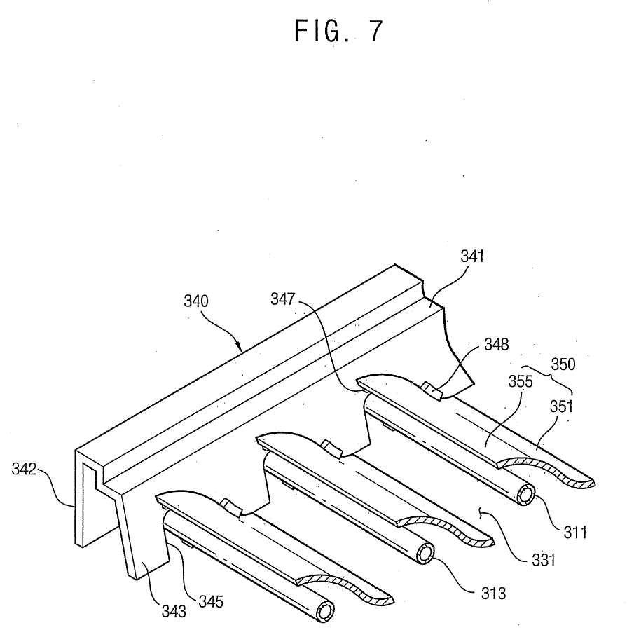

FIG. 7 is a partial perspective view illustrating a reflection plate 350 guided by the side cover in FIG. 5.

Referring to FIGS. 5 to 7, the reflection plate 350 may have a construction substantially the same as that of the reflection plate 150 described with reference to FIGS. 1 to 4 except for a shape of a connection protrusion 352.

For example, the reflection plate 350 includes a first reflection portion 351 and a second reflection portion 355. The connection protrusion 352 is formed on a lower end of the first reflection portion 351. The connection protrusion 352 has a length corresponding to that of a corresponding connection groove 332.

The connection protrusion 352 is inserted into the connection groove 332 positioned under the first lamp 311. The connection protrusion 352 is connected to the connection groove 332 to fix the first reflection portion 351 to the bottom plate 331. Here, the first reflection portion 351 exposes the first lamp 311 to a direction toward a space over the receiving container 330. The second reflection portion 355 extending from the first reflection portion 351 covers the second lamp 313 placed adjacent to the first lamp 311.

One of the side covers 340 guides one longitudinal end of the reflection plate 350 and connects to an upper end and a lower end of the reflection plate 350. In the same manner, the other side cover 340 guides the other longitudinal end of the reflection plate 350 corresponding to the other terminal end of the reflection plate 350.

More particularly, the reflection plate 350 slides on or over the first protrusion 347 of the inner supporting plate 343 of the side cover 340 and below the second protrusion 348. Then, the connection protrusion 352 of the first reflection portion 351 is combined with the connection groove 332 of the bottom plate 331.

Accordingly, the reflection plate 350 is securely fixed by the bottom plate 331 and the side covers 340 and is not moved by an outside impact.

FIG. 8 is a cross-sectional view taken along line II-II′ in FIG. 5.

Referring to FIG. 8, the optical member 360 may improve optical characteristics including luminance uniformity and a front luminance of visible light rays emitted to a space over the receiving container 330. The optical member 360 includes a diffusion unit 361 and condensing sheets 365.

The diffusion unit 361 diffuses the visible light rays emitted to the space over the receiving container 330 to improve the luminance uniformity of the visible light rays and to convert remaining ultraviolet light rays into the visible light rays. The stepped portions of the third and fourth sidewalls 317 and 319 and the upper plate 341 of the side covers 340 support the diffusion unit 361, as well as the condensing sheets 365.

The diffusion unit 361 has a diffusion plate 362 and a fluorescence layer 363. The diffusion plate 362 is transparent and has a plate shape. The diffusion plate 362 may include a polymer resin having a high light transmissivity, heat-resisting property, chemical resisting property and mechanical strength, etc. Examples of the polymer resin may include polymethylmethacrylate, polyamide, polyimide, polypropylene, polyurethane, for example, but are not limited thereto.

The fluorescent layer 363 is formed on a lower surface of the diffusion plate 362, that is, one surface side of the diffusion plate 362 facing the bottom plate 331 of the receiving container 330.

The ultraviolet light rays emitted from the first and second lamps 311 and 313 are converted into the visible light rays by the fluorescent layer of the surface of the bottom plate 331, the surface of the reflection plate 350 and the inner surface of the first to fourth sidewalls 333, 335, 337 and 339. However, some of the ultraviolet light rays may not be converted into the visible light rays by the fluorescent layer and be emitted to the space over the receiving container 330. Here, the fluorescent layer 363 formed on the lower surface of the diffusion plate 362 converts the remaining ultraviolet light rays into the visible light rays.

The condensing sheets 365 are placed on a surface of the diffusion plate 362. The condensing sheet 365 changes a course of the visible light rays emitted from the diffusion plate 362 close to a front direction of the condensing sheets 365. In this exemplary embodiment, the backlight assembly 300 includes a pair of the condensing sheets 365. In other alternative exemplary embodiments, any number of the condensing sheets may be used.

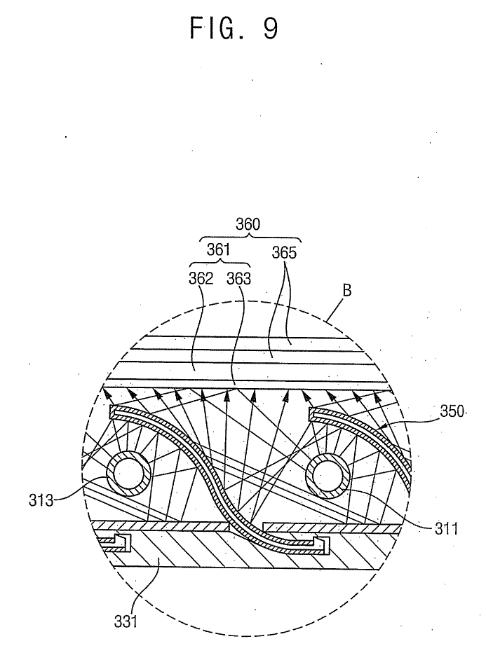

FIG. 9 is an enlarged view illustrating portion B in FIG. 8.

Referring to FIG. 9, the reflection plate 350 extends from a right side of the first lamp 311 to the space above the second lamp 313 and to a left side of the first lamp 311, as illustrated, to reflect the ultraviolet light rays emitted from the first lamp 311 mainly toward a side-direction (e.g., a direction parallel with the optical member 360). Here, the ultraviolet light rays incident on the reflection plate 350 are converted into the visible light rays by the fluorescent layer formed on the surface of the reflection plate 350.

On the other hand, the reflection plate 350 extends from under the first lamp 311 to a left side of the second lamp 313, as illustrated in FIG. 9, to reflect the ultraviolet light rays emitted from the first lamp 311 and the visible light rays reflecting from the reflection plate 350 extending from a right side of the first lamp 311 to the space above the second lamp 313 mainly toward the space above the receiving container 330. Here, the ultraviolet light rays are converted into the visible light rays by the fluorescent layer 363.

As the reflection plate 350 has the curved profile as mentioned above, the visible light rays reflecting from the reflection plate 350 are not concentrated in a specified direction and are uniformly disperse. More particularly, the visible light rays emitted from the first lamp 311 to a space over the first lamp 311 may reflect many times on the reflection plate 350 covering the space over the first lamp 311 and the bottom plate 331 to be emitted to the space over the receiving container 330. Accordingly, a luminance of a region corresponding to the space over the first lamp 311 in the optical member 360 does not become higher than that of any other region, thus eliminating or effectively preventing a bright line from occurring and deteriorating a display quality of the display panel.

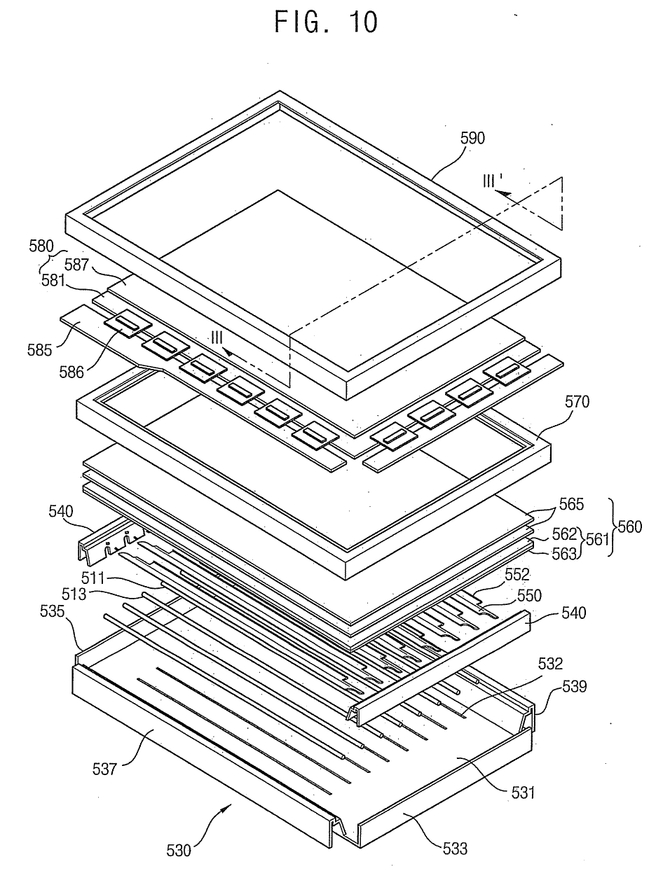

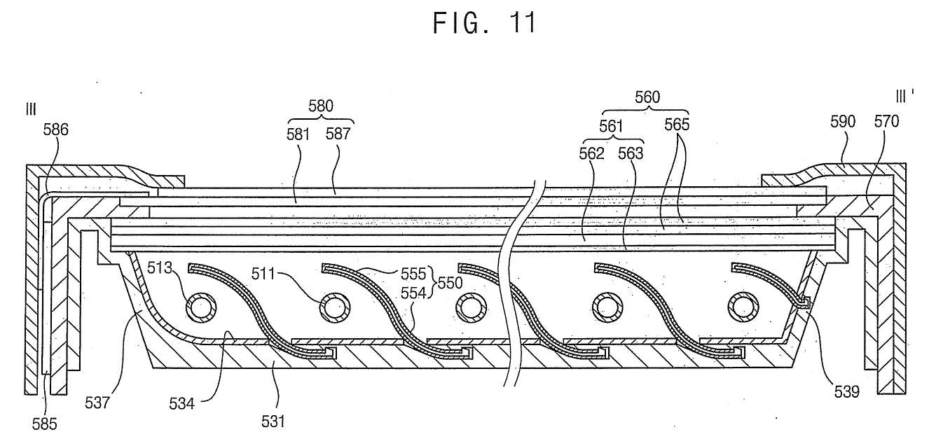

FIG. 10 is an exploded perspective view illustrating a display device in accordance with another exemplary embodiment of the present invention. FIG. 11 is a cross-sectional view taken along line III-III′ in FIG. 10.

Referring to FIGS. 10 and 11 the display device 500 includes a receiving container 530, a plurality of lamps 511 and 513, a plurality of reflection plates 550 and a display panel 580.

The receiving container 530, the lamps 511 and 513 and the reflection plates 550 may have a construction substantially the same as that of the receiving container 330, the lamps 311 and 313 and the reflection plates 350 described with reference to FIG. 5 except for the display panel 580.

The display device 500 further includes a middle mold 570. The middle mold 570 is connected to the receiving container 530 by pressing an edge of an optic member 560. For example, the middle mold 570 has a frame portion and a cover portion.

The frame portion has a rectangular frame shape with an opened portion corresponding to a bottom plate 531. Stepped portions are formed on the frame portion. The display panel 580 is positioned on the stepped portions of the frame portion. The cover portion extends from an outer edge of the frame portion extending substantially toward the vertical direction. The frame portion is placed on first to fourth sidewalls 533, 535, 537 and 539 of the receiving container 530 and the cover portion is placed to cover an outside of the first to fourth sidewalls 533, 535, 537 and 539.

The display panel 580 displays an image using the visible light rays having improved luminance uniformity due to the reflection plate 550 and having improved luminance uniformity and front luminance by an optical member 560. The stepped portions of the frame portion support the display panel 580. The display panel 580 includes a first substrate 581, a second substrate 587 and a liquid crystal layer disposed therebetween.

The first substrate 581 may have a lower substrate, a pixel electrode and a switching element. The pixel electrode is placed on the lower substrate. The lower substrate includes a plurality of pixel electrodes disposed in a matrix in exemplary embodiments. The pixel electrode is transparent and conductive. The switching element applies a driving signal of a panel to the pixel electrode.

The second substrate 587 has an upper substrate, a color pixel and a common electrode. The upper substrate is spaced apart from the lower substrate by a predetermined distance and faces the lower substrate. The color pixel is placed on the upper substrate corresponding to the pixel electrode. The color pixel receives a light and passes the light having a predetermined wavelength. The common electrode is positioned corresponding to the pixel electrode on one side of the upper substrate on which the color pixel is placed. The common electrode has a transparent conductive material.

The display panel 580 further includes a printed circuit board 585 and a connection film 586. The printed circuit board 585 generates the driving signal of the panel and the connection film 586 electrically connects the printed circuit board 585 to the first substrate 581.

When an electric field is formed between the pixel electrode and the common electrode according to the driving signal of the panel provided from the printed circuit board 585 through the connection film 586, the arrangement of liquid crystal layer between the pixel electrode and the common electrode varies. Accordingly, a transmittance of a light provided from the optical member 560 to the display panel may be changed and then the display device 500 may display an image having a predetermined gradation.

The display device 500 exposes a display region of the display panel 580 and further includes a top chassis 590 combined with the receiving container 530.

According to the present invention, a reflection plate having a curved profile extends from under a first lamp to a space over a second lamp adjacent to the first lamp. Therefore, a ratio of light directly incident on an optical member from the first and second lamps is decreased. On the contrary, a ratio of reflecting light incident on the optical member is increased in accordance with a reflection of the light on the reflection plate. As a result, luminance uniformity of emitted light may be improved in a backlight assembly and generation of a bright line is largely eliminated or effectively prevented in a display device.

The reflection plate reflects a light toward a side direction, that is, a light emitted from the first lamp is reflected toward the second lamp and a light emitted from the second lamp is reflected toward the first lamp to be reflected on the optical member. As the light toward the side direction, which is conventionally unused, is used in the present invention, luminance of emitted light from the backlight assembly is improved.

In the exemplary embodiments of the present invention, lamps as a light source emits ultraviolet light rays. The ultraviolet light rays have a bandwidth narrower than that of visible light rays emitted from a fluorescent body. Therefore, the light may be easily and accurately controlled to then be efficiently used in a backlight assembly and a display device having the backlight assembly.

In the exemplary embodiments of the present invention, a fluorescent layer is formed on a lower surface of a diffusion plate, a surface of the reflection plate and a surface of a bottom plate which is spaced apart from the first and second lamps. Deterioration of a color of the fluorescent body consisting of the fluorescent layer is largely decreased to improve a lifetime of the backlight assembly and the display device. According to an increase of a surface area of the fluorescent layer emitting the visible light rays, luminance of the visible light rays emitted from the backlight assembly is improved.

Because the reflection plate has a profile to provide uniform luminance of emitted light, a distance between the optical member and the lamps may be narrow. Accordingly, a thickness of the backlight assembly and the display device may be deceased resulting in a thinner backlight assembly.

The foregoing is illustrative of the present invention and is not to be construed as limiting thereof. Although a few exemplary embodiments of the present invention have been described, those skilled in the art will readily appreciate that many modifications are possible in the exemplary embodiments without materially departing from the novel teachings and advantages of the present invention. Accordingly, all such modifications are intended to be included within the scope of this invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as being limited to the specific exemplary embodiments disclosed herein, and that modifications to the disclosed exemplary embodiments, as well as other embodiments, are intended to be included within the scope of the appended claims. The present invention is defined by the following claims, with equivalents of the claims to be included therein.

What is claimed is:

1. A backlight assembly, comprising:
first and second lamps emitting ultraviolet light rays;
a receiving container including a bottom plate on which the first and second lamps are arranged substantially parallel to each other; and
a reflection plate fixed on the bottom plate under the first lamp and extending to a space above the second lamp, the reflection plate having a first fluorescent layer that converts the ultraviolet light rays into visible light rays.

2. The backlight assembly of claim 1, wherein the reflection plate includes a first reflection portion having a concave shape that surrounds the first lamp and a second reflection portion connected to the first reflection portion and having a concave shape that surrounds the second lamp.

3. The backlight assembly of claim 1, wherein the reflection plate extends along a longitudinal direction of the first and second lamps.

4. The backlight assembly of claim 1, wherein a first connection part is formed at a lower end of the reflection plate and a second connection part connected to the first connection part is formed at the bottom plate.

5. The backlight assembly of claim 4, wherein the first connection part and the second connection part comprise a connection protrusion and a connection groove, respectively, or vice versa.

6. The backlight assembly of claim 1, wherein a second fluorescent layer converting the ultraviolet lays into the visible lays is formed on the bottom plate.

7. The backlight assembly of claim 1, wherein the receiving container further comprises a sidewall placed on an edge of the bottom plate and a second fluorescent layer is formed on an inner surface of the sidewall.

8. The backlight assembly of claim 7, further comprising an optical member supported by the sidewall of the receiving container and improving optical characteristics of the visible light rays.

9. The backlight assembly of claim 8, wherein a third fluorescent layer is formed on a lower face of the optical member facing the bottom plate.

10. The backlight assembly of claim 1, further comprising a side cover receiving either of opposite ends of the first and second lamps and fixing a respective end of the reflection plate.

11. The backlight assembly of claim 10, wherein the side cover includes an upper plate, an outer supporting plate and an inner supporting plate, wherein the inner supporting plate includes grooves to receive a respective lamp for preventing the lamps from interfering with each other.

12. The backlight assembly of claim 11, wherein the inner supporting plate includes first and second protrusions to receive and guide the reflective plate.

13. The backlight assembly of claim 12, wherein the first protrusion is formed over a corresponding groove and the second protrusion is formed between adjacent grooves, contacting surfaces of the first and second protrusions which make contact with the reflection plate have a curved surface contoured to a profile of the reflection plate.

14. A display device, comprising:
a receiving container;
a plurality of lamps arranged parallel with each other on a bottom plate of the receiving container and emitting ultraviolet light rays;
a plurality of reflection plates secured to the bottom plate between the lamps and extending to a space above any one of the lamps, the reflection plates having a first fluorescent layer which converts the ultraviolet light rays into visible light rays; and
a display panel which displays an image using the visible light rays.

15. The display device of claim 14, wherein the reflection plate includes a first reflection portion having a concave shape that surrounds the first lamp and a second reflection portion connected to the first reflection portion and having a concave shape that surrounds the second lamp.

16. The display device of claim 14, wherein the bottom plate has a slot and a lower end part of the reflection plate is inserted into the slot.

17. The display device of claim 14, wherein the receiving container includes a sidewall placed on an edge of the bottom plate and a second fluorescent layer is formed on an inner surface of the bottom plate and the sidewall.

18. The display device of claim 14, further comprising an optical member positioned between the lamps and the display panel, the optical member improving optical characteristics of the visible light rays provided to the display panel.

19. The display device of claim 18, wherein a third fluorescent layer is formed on a lower face of the optical member.
